(19) United States
(12) Patent Application Publication
(10) Pub. No.: US 2011/0003576 A1
(43) Pub. Date: Jan. 6, 2011

(54) METHOD AND APPARATUS FOR PROVIDING IMMEDIATE ASSISTANCE IN A COMMUNICATION SYSTEM

(75) Inventors: Wei Sun, Singapore (SG); Khan Illum, Singapore (SG); Yat Hong Wong, Subang Jaya (MY)

Correspondence Address: MOTOROLA, INC.;Penny Tomko, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/495,864

(22) Filed: Jul. 1, 2009

(51) Int. Cl. H04M 11/04

(52) U.S. Cl. 455/404.1

(57) ABSTRACT

A method and apparatus for providing immediate assistance based on a required service. The method includes classifying (202) a plurality of profiles for a plurality of services required by a source communication device. The method further includes selecting (204) one of the profiles and assigning (206) a priority to the profiles based on the service required. Upon selecting the profiles and assigning a priority to the profiles, the method further includes initiating (210, 216) a service request based on the selected profile. The service request enables the source communication device to establish a call with at least one of the plurality of target communication devices located near the source communication device, wherein the call is established based on the priority assigned to various profiles in the service request.

### FIELD OF THE DISCLOSURE

The present disclosure relates generally to a communication system and more particularly to a method and apparatus for providing immediate assistance in a communication system.

### BACKGROUND

Over the decades, emergency assistance systems have improved tremendously. Also, the methods for enabling a user to access emergency assistance systems have improved. Presently, there are various methods such as a public emergency numbers (e.g. 911), speed dial functions on mobile phones, and emergency broadcast system that enables the user to access an emergency assistance system in a minimum amount of time. However, in some situations these methods may have some delay either due to distance or traffic conditions. In such situations the user may need someone physically nearby to come for instant help or assistance.

Apart from emergency situations, there are various non-emergency situations where a user requires minor assistance from people close by, such as when the user has forgotten keys/access-card, when the user is in a new town or other situations wherein the user's car breaks down, when the user has forgotten to carry his wallet, or in situations where the user may need help. Despite the fact that almost every individual in every city today carries a mobile phone, it is difficult to call someone who is nearby without knowing their whereabouts and also their mobile number.

Accordingly, there is a need for a method and apparatus for providing immediate assistance in a communication system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system in accordance with some embodiments.

FIG. 2 is a flowchart of a method for initiating a service request in accordance with some embodiments.

FIG. 3 is a flowchart of a method for establishing a call in accordance with some embodiments

FIG. 4 is a schematic of a plurality of profiles in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention relates to a method and device for providing immediate assistance based on a required service. The method includes classifying a plurality of profiles for a plurality of services required by a source communication device. The required service can be an emergency service or a non-emergency service. The method further includes selecting one of the profiles and assigning a priority to the profiles based on the service required. Upon selecting the profiles and assigning a priority to the profiles, the method further includes initiating a service request based on the selected profile. The service request enables the source communication device to establish a call with at least one of the plurality of target communication devices located near the source communication device, wherein the call is established based on the priority assigned to various profiles in the service request. Advantages of the various embodiments include: enabling a user to quickly contact someone physically nearby for assistance and thereby providing the user with faster or quicker help without the user's manual intervention and unnecessary delay. Those skilled in the art will realize that the above recognized advantages and other advantages described herein are merely illustrative and are not meant to be a complete rendering of all of the advantages of the various embodiments.

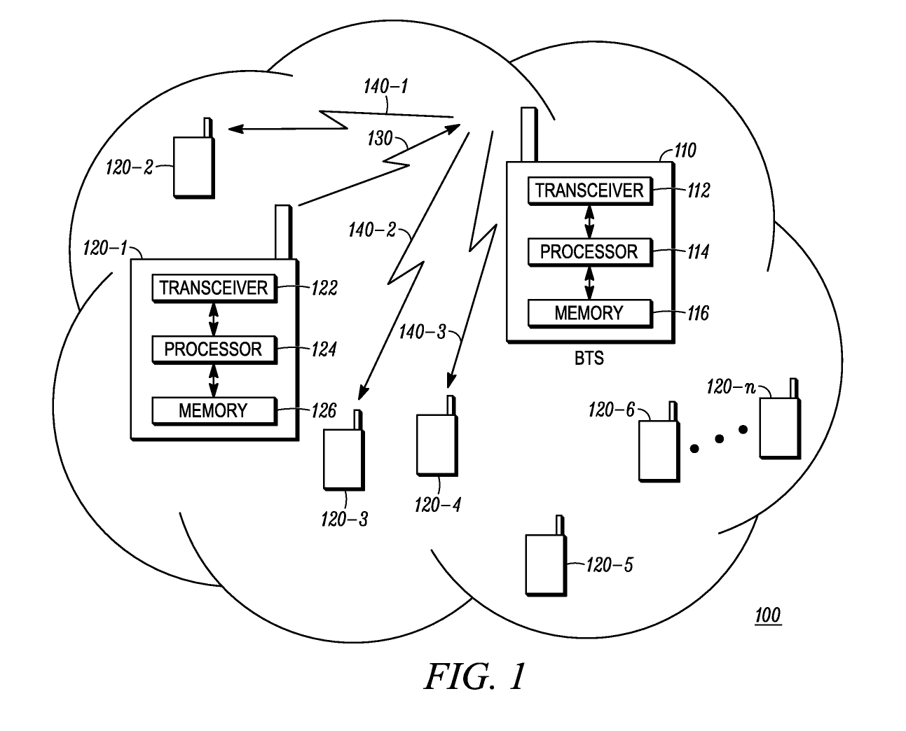

Referring now to figures, FIG. 1 is a block diagram of a communication system 100 in accordance with some embodiments. The communication system 100 may include, but not limited to a cellular communication system, a mobile communication system, and a wireless local area network (WLAN). The communication system 100 includes a base station (BS) 110 and a plurality of communication devices 120-1, 120-2, 120-3 . . . 120-n such that the BS 110 can communicate with each of the plurality of devices. For example, a communication device 120-1 can initiate a service request to the BS 110 when the user of the communication device needs some immediate help or assistance according to the embodiments described. The BS 110, upon receiving the request, establishes a call between the initiating communication device 120-1 and a target communication device (one of 120-2, 120-3 . . . 120-n) physically nearer to the initiating device.

The BS 110 is at least equipped with a transceiver (i.e., transmitter and receiver apparatus) 112, a memory 116 and a processing device 114 and is further equipped with any additional components as needed for a commercial embodiment. The transceiver 112, memory 116 and processing device 114 can have any suitable physical implementation and are topologically coupled depending on the particular device implementation. These components are further operatively coupled and can be adapted, arranged, configured, and designed to perform methods in accordance with the teachings herein, for example, as illustratively described with reference to the FIGS.

As used herein, a BS is a piece of infrastructure equipment that can receive information (either control or media, e.g., data, voice, etc.) in a wireless signal from a communication device and transmit information in wireless signals to one or more communication devices via a communication link as well as to other network equipment (not shown) as is known in the art. A BS includes, but is not limited to, equipment commonly referred to as base transceiver stations, access points, routers or any other type of device interfacing a communication device in a wireless environment.

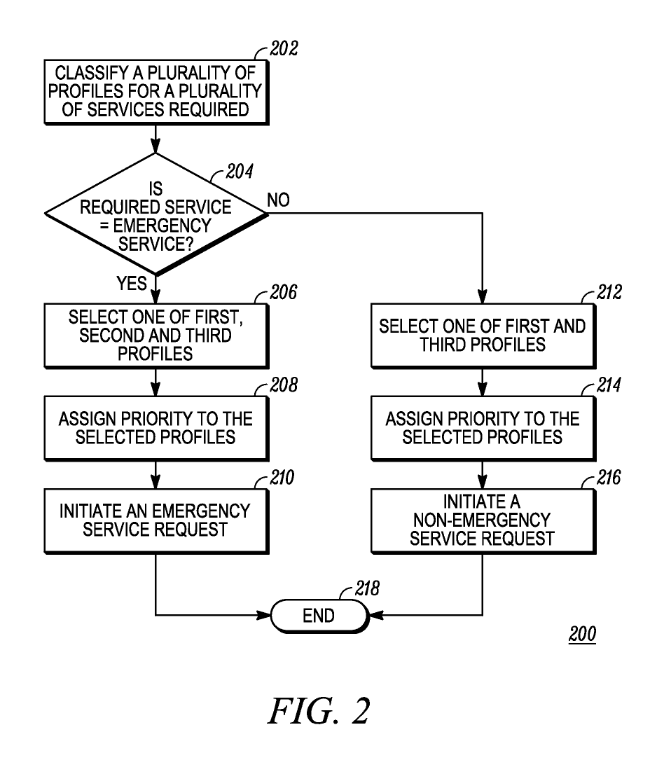

Referring back to system 100, the plurality of communication devices 120-1, 120-2, 120-3, . . . 120-n are each equipped with a transceiver (i.e., transmitter and receiver apparatus) 122, a memory 126 and a processing device 124 and is further equipped with any additional components as needed for a commercial embodiment. The transceiver 122, memory 126 and processing device 124 can have any suitable physical implementation and are topologically coupled depending on the particular device implementation. These components are further operatively coupled and can be adapted, arranged, configured, and designed to perform methods in accordance with the teachings herein, for example, as illustratively described with reference to the FIG. 2. For ease of illustration the transceiver 122, memory 126, and processing device 124 are shown for only one communication device 120-1, however all the other communication devices also include the transceiver 122, memory 126 and processing device 124.

As referred to herein, a communication device includes, but is not limited to, devices commonly referred to as mobile radios, mobile stations, subscriber units, user equipment, mobile devices, or any other device capable of operating in a wireless environment. Examples of communication devices include, but are not limited to, two-way radios, mobile phones, cellular phones, Personal Digital Assistants (PDAs), laptops and pagers.

In general, the communication links include the physical communication resources over which information is sent between the elements within system 100. Communication links can be wireless. For example, as illustrated in FIG. 1, the communication device 120-1 communicates with BS 110 via an uplink channel 130, the BS 110 communicates with communication devices 120-2, 120-3, and 120-4 via downlink channels 140-1, 140-2, and 140-3, respectively.

Only a single BS and a limited number of communication devices are shown for ease of illustration. However, system 100 can include any number of BSs to support any number of communication devices based on system requirements.

FIG. 2 is a flow diagram of a method 200 in accordance with some embodiments. Method 200 is used by a communication device, e.g., a source communication device 120-1 in the system 100 for initiating a service request in order to get some immediate assistance or help from a target communication device. At 202, the source communication device 120-1 classifies a plurality of profiles based on a plurality of services needed by the communication device 120-1. Each of the plurality of profiles contains a list of identities associated with different categories of target communication devices. For example, a first profile can be for friends and relatives that can be found in a user's phonebook. A second profile can be for emergency numbers such as fire service, police, ambulance service, security services etc. and can be 911 and other numbers that are used to contact such services, and a third profile can be for random users located near the communication device requesting the assistance. These profiles can be stored at numerous locations such as the source communication device, a base station or other network entity.

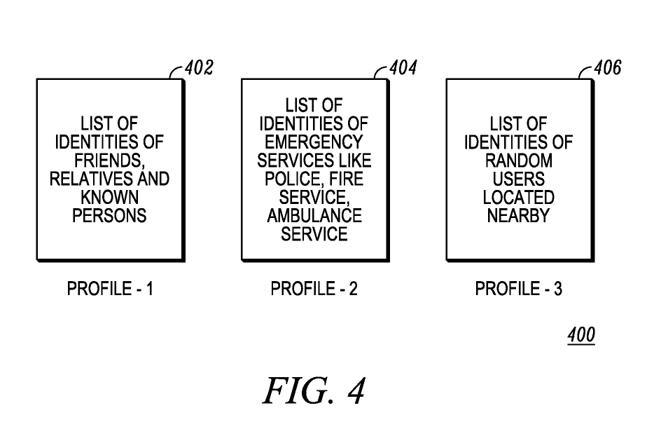

Referring now to FIG. 4, a schematic of a plurality of profiles in accordance with some embodiments is shown. The plurality of profiles 400 are classified by the source communication device 120-1 based on a service required by the source device 120-1, wherein the plurality of profiles includes a first profile 402, a second profile 404, and a third profile 406. The first profile 402 is a list of identities such as a list of landline telephone numbers and mobile phone numbers of friends, relatives, colleagues, and anyone personally known to the user of the source device 120-1. The list for the first profile is stored in the source device 120-1 or another suitable location within the network. The second profile 404 is a list of identities such as a list of landline telephone numbers and a list of mobile numbers associated with various emergency services such as, but not limited to security services such as police, security guards, etc., fire services, ambulance services, red-cross, etc. The second profile is not restricted to 911 numbers, but can include other numbers that provide access to emergency personnel other than by well known emergency 911 numbers. The list of identities in the second profile can be stored in the source device 120-1 or another suitable location within the network. Alternatively, the source device can subscribe for these services from the BS 110. The third profile 406 is a list of identities such as a landline telephone number or a mobile number of a random user such as, a passerby who is physically near to the source device 120-1 in the system 100. The list of identities in the third profile can be randomly chosen by the BS 110 based on detecting the location of the source device 120-1 and identifying the plurality of target communication devices that are physically near to the source device. The third list can also include users who have subscribed to a service so that they use the service and at the same time permit the BS 110 to contact them as a member of the third profile whenever there is a service request. The plurality of identities as mentioned above can be telephone numbers or other identifications such as IP addresses, etc. of the target communication devices.

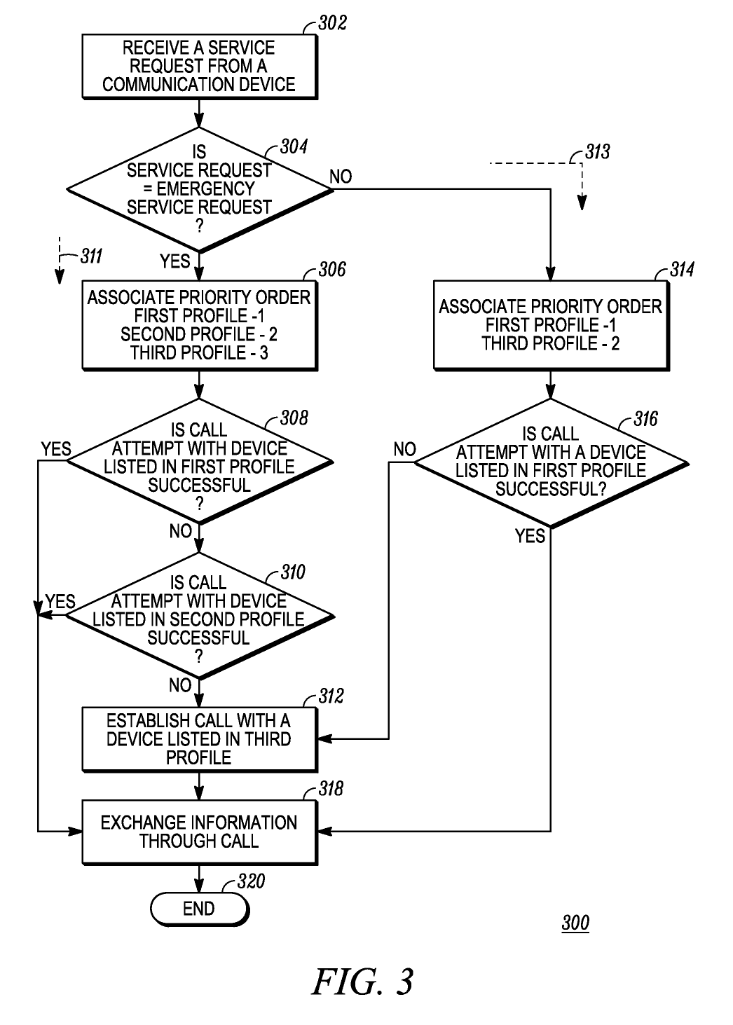

Turning back to FIG. 2, after classifying the profiles 202, the source communication device 120-1 determines 204 a required type of service such as an emergency service or a non-emergency service based on a situation. When there is an emergency situation such as fire, robbery, an accident etc., then the required service is an emergency service. When the situation is a non-emergency situation such as finding whether there is a known person in the close by area in order to ask for some directions or immediate cash, etc., then the required service is a non-emergency service. Upon determining the type of service the source device 120-1 selects at least one of the profiles and assigns a priority to the profiles based on the user's needs. The type of service can be determined by the user selecting an emergency or non-emergency service as a part of process of initiating the service on the communication device. The determination can be made by pushing a button on the communication device, selecting a menu item or other suitable process. This selection initiates a service request in order to enable the BS 110 to establish a call with a target communication device e.g. one of 120-2, 120-3, and 120-4. The target communication device will be selected by the BS 110 based on the determined service, on the identities listed in the profile and the location of the target device with respect to the location of the source device 120-1. The method of establishing a call between the source device and at least one of the plurality of target devices will be illustrated by FIG. 3 and its accompanying description.

In one embodiment, upon determining 204 the required service to be an emergency service the source device 120-1 selects 206 at least one of the first profile, the second profile, and the third profile. The source device 120-1 then assigns 208 a priority to the selected profiles. In one embodiment, the first profile has the highest priority over the second and third profiles and the second profile has a higher priority over the third profile. In another embodiment, the second profile has the highest priority over the first and the third profiles and the first profile has a higher priority over the third profile. The profiles can be prioritized in different orders depending on the needs of the source communication device and the nature of the situation. The prioritizations can be made by the user at the time that the service is initiated by the user or pre-assigned by the user depending on the selected service and situation. Upon selecting the profiles and assigning the priority the source device initiates 210 an emergency service request to the BS 110 over the link 130. The emergency service request will be initiated when the user of the source communication device 120-1 presses a button in the communication device or dials a special number or assigns a speed dial. The service request can also be initiated using various other methods that are already known in the art. The method 200 ends at 218.

In another embodiment, upon determining 204 the required service to be a non-emergency service the source device 120-1 selects 212 at least one of the first and the third profiles. The source device 120-1 then assigns 214 a priority to the selected profiles. In one embodiment, the first profile has a higher priority over the third profile. The profiles can be prioritized in different orders depending on the needs of the source communication device and the nature of the situation. Upon selecting the profiles and assigning the priority the source device initiates 216 a non-emergency service request to the BS 110 over the link 130. The non-emergency service request will be initiated when the user of the source communication device 120-1 presses a button in the communication device or dials a special number or assigns a speed dial. The service request can also be initiated using various other methods that are already known in the art. The method 200 ends at 218.

FIG. 3 is a flow diagram of a method 300 in accordance with some embodiments. Method 300 is used by an infrastructure device, e.g., a base station (BS) 110 in the system 100. The BS 110 receives a service request from a source communication 120-1 over a communication link 130 and establishes a call between a source device 120-1 and a target device (e.g., one of 120-2, 120-3 . . . 120-n), based on the service request. Upon receiving the service request the BS 110 determines 304 the type of service request such as an emergency service request or a non-emergency service request and associates a priority with various profiles based on the service request. In addition, the BS may also include predefined priorities associated with predefined profiles/groups. However, these priorities can be changed based on the priorities in the service request. Based on the priority, the BS 110 attempts to call at least one of the target devices (e.g., one of 120-2, 120-3 . . . 120-n) over at least one of the links 140-1, 140-2, and 140-3 and establishes the call between the source device 120-1 and at least one of the target devices (e.g., one of 120-2, 120-3 . . . 120-n).

In one embodiment, the BS 110 receives 302 a service request and determines 304 that the service request is an emergency service request. The BS 110 associates 306 priorities with the profiles in the emergency service request. In one embodiment, the first profile has the highest priority over the second and third profiles and the second profile has a higher priority over the third profile. In another embodiment, second profile has the highest priority over the first and the third profiles and the first profile has a higher priority over the third profile. The profiles can be prioritized in different orders depending on the needs of the source communication device and the nature of the situation.

In one embodiment, when the first profile has the highest priority over the second and third profiles and the second profile has a higher priority over the third profile, the BS attempt to establish a call as discussed below. The BS 110 attempts to establish 308 a call between the source communication device 120-1 and at least one of the plurality of target communication devices 120-2, 120-3 . . . 120-n associated with one of the identities as listed in the first profile and that is physically near the source communication device 120-1 .The location of the source and target communication devices can be determined using standard location determination services such as GPS services or any other location determination services already known in the art. The first profile contains a list of identities such as landline telephone numbers or mobile telephone numbers of friends and relatives that can be found in a user's phonebook and is stored in the source communication device 120-1. Once a call is established the source device starts to exchange 318 information with the target device over a voice call and the method 300 ends at 320. If the BS 110 cannot establish a call between the source communication device 120-1 and the first selected target communication device, the BS 110 can select another identity from the first priority to contact if it is determined that the location of the next communication device is in a proximate range of the source communication device. In an embodiment, the first profile may have the highest priority, but it is determined that there are no target communication devices from the first profile that are near or proximate to the source communication device. Thus, the method goes directly to the next priority profile.

If the BS 110 is not able to establish a call between the source communication device 120-1 and at least one target communication device (one of 120-2, 120-3 . . . 120-n) listed in the first profile then the BS 110 proceeds to establish 310 a call between the source communication device 120-1 and another target communication device associated with at least one of the identities listed in the second profile. There can be various reasons for the BS 110 not being able to establish the call such as the target communication device is not physically near to the source device 120-1 or the target device is in switched off mode or the target device is busy with another call, etc,. The second profile contains a list of identities such as landline telephone numbers or mobile telephone numbers that correspond to a list of emergency service providers such as fire men, police, security guards, ambulance service, red-cross, etc. Once a call is established the source device starts to exchange 318 information with the target device over a voice call and the method 300 ends at 320.

If the BS 110 is not able to establish a call between the source communication device 120-1 and the target communication device (one of 120-2, 120-3 . . . 120-n) listed in the second profile then the BS 110 proceeds to establish 312 a call between the source communication device 120-1 and another target communication device associated with at least one of the identities listed in the third profile. There can be various reasons for the BS 110 not being able to establish the call such as the target communication device is not physically near to the source device 120-1 or the target device is in switched off mode or the target device is busy with another call, etc,. The third profile 406 contains a list of identities such as a landline telephone numbers or mobile telephone numbers that correspond to a set of random users located near the communication device requesting for assistance. Once a call is established the source device starts to exchange 318 information with the target device over a voice call and the method 300 ends at 320.

In another embodiment, when the second profile has the highest priority over the first and third profiles and the first profile has a higher priority over the third profile, the BS attempts to establish a call similar to the manner discussed above. However, the order of priority changes, i.e., the BS 110 initially attempts to establish calls with target communication devices defined by the second profile. If that fails then the BS proceed with the first and third profiles similar to the manner discussed in the above paragraphs. Once a call is established the source device starts to exchange 318 information with the target device over a voice call and the method 300 ends at 320

Referring again to FIG. 3, method 300, in one embodiment, the BS 110 receives 302 a service request and determines 304 that the service request is a non-emergency service request. The BS 110 associates 306 priority with the profiles in the non-emergency service request. In one embodiment, the first profile has a higher priority over the third profile. The BS 110 then proceeds to establish 316 a call between the source communication device 120-1 and at least one of the plurality of target communication devices 120-2, 120-3 . . . 120-n. The target communication device is associated with at least one of the identities listed in the first profile and is physically near to the source communication device 120-1. The first profile 402 contains a list of identities such as a landline telephone number or mobile telephone number that corresponds to a list of persons known to the user of the source communication device 120-1. Once a call is established the source device starts to exchange 318 information with the target device (one of 120-2, 120-3 . . . 120-n) over a voice call and the method 300 ends at 320.

If the BS 110 is not able to establish a call between the source communication device 120-1 and the target communication device (one of 120-2, 120-3 . . . 120-n) listed in the first profile then the BS 110 proceeds along the path 313 to establish 316 a call between the source communication device 120-1 and another target communication device associated with at least one of the identities listed in the third profile. The third profile 406 contains a list of identities such as a landline telephone numbers or mobile telephone numbers that correspond to a set of random users located near the communication device requesting the assistance. Once a call is established the source device starts to exchange 318 information with the target device over a voice call and the method 300 ends at 320.

Further referring to method 300, in one another embodiment, the target device (of 120-2, 120-3 . . . 120-n) in a profile can reject a call from the BS 110. In such a scenario, the BS 110 selects another target device from the plurality of identities in the selected profile other than the initially selected target device that is also near to the source device 120-1. The BS 110 continues with its attempt to establish the call until a call is established between the source device 120-1 and at least one of the target communication devices (one of 120-2, 120-3 . . . 120-n) in that profile. When there are no more identities in a profile, the BS 110 can select identities from the profile with the next priority. Also, if the BS 110 is not able to establish the call within a particular time period it can notify the source device 120-1 and let the source device 120-1 to decide whether a service request retry is needed some time later.

In one example, a user of the source communication device 120-1 (a first user) has lost his way in a new town. In this situation, the first user selects the first, second, and third profiles and assigns priority to the profiles such that the first profile has the highest priority and the second profile has the second highest priority. The first user then presses a special key or button or uses a menu in the source communication device 120-1, such that the source communication device 120-1 initiates an emergency service request to the BS 110. Upon receiving the emergency service request, the BS 110 associates 306 priorities with the profiles and attempts to establish a call between the source device 120-1 and at least one of the plurality of target communication devices 120-2, 120-3 . . . 120-n. Initially, the BS 110 attempts to establish 308 a call between the first user and a second user associated with at least one of the plurality of target communication devices 120-2, 120-3 . . . 120-n having an identity listed in the first profile. Moreover, the selected target communication device is physically near to the first user. The first user is then able to talk to the second user and explain to the second user about the situation and ask the second user for help. The second user can be a friend or a relative to the first user and is personally known to the first user.

In case the at least one target device (one of 120-2, 120-3 . . . 120-n) listed in the first profile is not physically near to the source device 120-1, then the BS 110 establishes a call 310 between the first user and a user in the next priority like a third user having an identity listed in the second profile and is physically near to the first user. The first user is then able to talk to the third user and explain the third user about the situation and ask the third user for help. The third user can be a police man or a security guard who can immediately reach the first user and provide help who is contacted through the service described instead of through 911 emergency services.

In case the at least one target device (one of 120-2, 120-3 . . . 120-n) listed in the second profile is not physically near to the source device 120-1, then the BS 110 establishes 312 a call between the first user and a user in the next priority like a fourth user, having an identity listed in the third profile and is physically near to the first user. The first user is then able to talk to the fourth user. The fourth user can be any user who is willing to help the first user and is also physically near to the first user. In one embodiment, the fourth user may be a subscriber to a service that indicates the user's willingness to accept calls. The BS 110 determines the physical proximity between all the users in the system 100 such that the second, third, or the fourth user can reach the first user within minimum possible time.

In another example, a user of the source communication device 120-1 (a first user) is in a deserted area when their car breaks down and therefore needs immediate assistance from someone nearby. In this situation, the user selects the first profile and third profile and assigns a priority such that the first profile has a higher priority over the third profile. The user then presses a special key or button in the source communication device 120-1, such that the source communication device 120-1 initiates a non-emergency service request to the BS 110. Upon receiving the non-emergency service request the BS 110 attempts to establish a call between the first user and a second user associated with an identity listed in the first profile and is physically near to the first user. The first user is then able to talk to the second user, who is a friend or colleague of the first user because these are the identities on the first profile, and requests the second user for assistance. The call is established between the first user and the second user by the BS 110, therefore, the first user need not go through his/her stored contact list and then dial the second user's number.

In case the at least one target device (one of 120-2, 120-3 . . . 120-n) listed in the first profile is not physically near to the source device 120-1 or does not respond to the call from the source device, then the BS 110 establishes a call 312 between the first user and a user in the next priority such as a third user, having an identity listed in the third profile and is physically near to the first user. The first user is then able to talk to the third user. The third user can be any user in the deserted area who is willing to help the first user and is also physically near to the first user.

In one another example, a user of the source communication device 120-1 (a first user) is near his/her office and has forgotten the access card. Therefore, he/she is not able to enter the office. In this situation, the user selects the first profile and presses a special key or button in the source communication device 120-1 to initiate a non-emergency service request to the BS 110. When the first user initiates the request to find assistance, the source communication device 120-1 processes the request by executing the applications and making the necessary choices. The BS 110 upon receiving the non-emergency service request attempts to establish the call between the first user and a second user having an identity listed in the first profile and is physically near to the first user. The first user is then able to talk to the second user, who is a friend or colleague of the first user, and requests the second user to help him/her come inside the office. The call is established between the first user and the second user by the BS 110, therefore, the first user need not go through his/her stored contact list and then dial the second user's number.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having”, “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
classifying a plurality of profiles for a plurality of services required by a source communication device, wherein each of the plurality of profiles contains a list of plurality of identities associated with a plurality of target communication devices;
selecting at least one of the plurality of profiles based on at least one of the plurality of services;
assigning a priority to the plurality of profiles based on at least one of the plurality of services; and
initiating a service request based on the selected profile, wherein the service request enables the source communication device to establish a call with at least one of the plurality of target communication devices located near the source communication device, wherein the at least one target communication device is associated with at least one of the plurality of identities in at least one of the plurality of profiles.

2. The method of claim 1, wherein the plurality of services required by the source communication device comprises at least one of an emergency service and a non-emergency service.

3. The method of claim 1, wherein the initiating a service request is based on at least one of pressing a button, selecting a menu item or dialing a number.

4. The method of claim 1, wherein the service request comprises at least one of an emergency service request and a non-emergency service request.

5. The method of claim 1, wherein the plurality of profiles comprises at least one of a first profile containing a list of plurality of identities stored in the source communication device, a second profile containing a list of plurality of identities associated with a list of plurality of emergency service providers, and a third profile containing a list of plurality of identities other than the list of plurality of identities in the first and second profile, wherein the list of plurality of identities in the third profile are associated with a list of plurality of target communication devices located near the source communication device.

6. The method of claim 5 further comprising:
initiating a non-emergency service request when the selected profile is at least one of the first profile and the third profile.

7. The method of claim 5 further comprising:
initiating an emergency service request when the selected profile is at least one of the first, second, and third profile

8. The method of claim 7, wherein the list of plurality of identities in the first profile and the second profile are associated with a list of plurality of target communication devices located near the source communication device.

9. A method comprising:
receiving a service request from a source communication device, wherein the service request is based on selecting at least one of a plurality of profiles by the source communication device, wherein the plurality of profiles corresponds with a plurality of services required by the source communication device; and
establishing a call between the source communication device and at least one of the plurality of target communication devices based on the service request, wherein the at least one target communication device is associated with at least one of the plurality of identities in at least one of the plurality of profiles and is located near the source communication device.

10. The method of claim 9, wherein each of the plurality of profiles contains a list of identities associated with a plurality of target communication devices.

11. The method of claim 9, wherein the service request comprises at least one of an emergency service request and a non-emergency service request.

12. The method of claim 10 further comprising:
associating a priority with the plurality of profiles based on the service request; and
establishing the call between the source communication device and at least one of the plurality of target communication devices based on the priority.

13. The method of claim 12, wherein establishing a call between the source communication device and at least one of the plurality of target communication devices further comprises associating the at least one target communication device with at least one of the plurality of identities listed in at least one of the first, second, and third profiles, when the service request is an emergency service request, wherein the first profile has a higher priority over the second and third profiles and the second profile has a higher priority over the third profile.

14. The method of claim 12, wherein establishing a call between the source communication device and at least one of the plurality of target communication devices further comprises associating the at least one target communication device with at least one of the plurality of identities listed in at least one of the first, second, and third profiles, when the service request is an emergency service request, wherein the second profile has a higher priority over the first and third profiles and the first profile has a higher priority over the third profile.

15. The method of claim 12, wherein establishing a call between the source communication device and at least one of the plurality of target communication devices further comprises associating the at least one target communication device with at least one of the plurality of identities listed in at least one of the first and third profiles, when the service request is a non-emergency service request, wherein the first profile has a higher priority over the third profile.

16. The method of claim 10, wherein the plurality of profiles comprises at least one of a first profile containing a list of plurality of identities stored in the source communication device, a second profile containing a list of plurality of identities associated with a list of plurality of emergency service providers, and a third profile containing a list of plurality of identities other than the list of plurality of identities in the first and second profile, wherein the list of plurality of identities in the third profile are associated with a list of plurality of target communication devices located near the source communication device.

17. The method of claim 16, wherein the list of plurality of identities in the first profile and the second profile are associated with a list of plurality of target communication devices located near the source communication device.

18. A device comprising:
a transceiver; and
a processing device coupled to the transceiver and programmed to perform a method comprising:
receiving a service request from a source communication device, wherein the service request is based on selecting at least one of a plurality of profiles by the source communication device, wherein the plurality of profiles corresponds with a plurality of services required by the source communication device; and
establishing a call between the source communication device and at least one of the plurality of target communication devices based on the service request, wherein the at least one target communication device is associated with at least one of the plurality of identities indicated by at least one of the plurality of profiles and is located near the source communication device.

19. The device of claim 18, wherein each of the plurality of profiles contains a list of identities associated with a plurality of target communication devices.

20. The device of claim 18, wherein the processing device is further programmed to perform:
assigning a priority to the plurality of profiles based on the service request; and
establishing the call between the source communication device and at least one of the plurality of target communication devices based on the priority.
